(19) United States
(12) Patent Application Publication
(10) Pub. No.: US 2024/0309193 A1
(43) Pub. Date: Sep. 19, 2024

(54) A SEALING ELEMENT WITH IMPROVED BONDING TO CEMENTITIOUS COMPOSITIONS

(71) Applicant: SIKA TECHNOLOGY AG, Baar (CH)

(72) Inventors: Blaise LEEBER, Burlington, MA (US); Fabian FREI, Weehawken, NJ (US)

(73) Assignee: SIKA TECHNOLOGY AG, Baar (CH)

(21) Appl. No.: 18/274,555

(22) PCT Filed: Mar. 28, 2022
(86) PCT No.: PCT/EP2022/058172

§ 371 Date: Jul. 27, 2023

(30) Foreign Application Priority Data
Apr. 1, 2021 (EP) 21166688.8

(51) Int. Cl. C08L 27/06; C08K 3/26; C08K 3/34; C08L 23/08; E04B 1/66

(52) U.S. Cl. CPC C08L 27/06; C08K 3/26; C08K 3/34; C08L 23/0853; E04B 1/66; C08K 2003/265; C08K 2201/005

(57) ABSTRACT

A scaling element including a filled polymeric layer including a polymer component including a polyvinylchloride resin and at least one ethylene vinyl acetate copolymer and at least one inorganic filler. The sealing element can be used as a waterbar or as a waterproofing membrane, to a method for scaling a joint between two sections of concrete, to a method for waterproofing a substrate, and to a method for producing a sealing element.

### TECHNICAL FIELD

The invention relates to sealing elements for use in the construction industry, for waterproofing of below or above ground building constructions. In particular, the invention relates to sealing elements, which are suitable for sealing of joints formed between casted sections of concrete and to sealing elements, which can be used for protecting below ground building structures against penetration of water.

### BACKGROUND ART

Polymeric sheets, which are often referred to as waterproofing membranes, are commonly used in the construction industry for sealing of bases, underground surfaces or buildings against water penetration. Waterproofing membranes are applied, for example, to prevent ingress of water through cracks that develop in the concrete structure due to building settlement, load deflection or concrete shrinkage. Furthermore, large concrete structures, such as slabs, dams, tanks, and foundations, cannot be casted as one monolithic unit and, therefore, they contain several joints formed between the concrete bodies. These concrete joints also must be sealed to prevent passage of water into and through the joint.

Waterproof profiles, also known as waterbars or waterstops, are commonly used for sealing of concrete joints. They are provided in a range of different compositions, shapes and sizes to suit different types of concrete structures and sealing applications. Joints are provided between adjacent concrete bodies to accommodate expected physical changes of concrete when subjected to environmental and mechanical conditions or to assist in the construction and placement of concrete. Physical changes may result from drying, shrinkage, carbonation, or creep of the concrete mass or from a load applied on the concrete body. The joint can also be formed, for example, due to a scheduled or unscheduled interruption in concrete placement.

Expansion joints are formed in concrete structures at regular intervals to accommodate the movement caused by expansion of concrete mass. Expansion joints are also commonly designed to isolate structural elements from each other, such as walls or columns from floors and roofs, pavement from bride decks, or where wall elements change directions. Contraction joints are used to regulate the cracking that occurs due to unavoidable and unpredictable contraction during hardening of concrete. Contraction joints may be made during casting of the concrete by forming the joint with a plate or after construction by cutting the joint. Construction joints are created at certain locations during massive concrete placements due to scheduled or unscheduled interruptions. In this case the concrete bodies are not expected to have dimensional changes and, therefore, construction joints are not provided with a predetermined expansion gap.

Waterbars are typically provided as strip-like profiles having a center portion and two side portions or side flanges located on opposite sides of the center portion. Depending on the application, the center position of a waterbar can be positioned inside the concrete joint to be formed (“internal waterbar”) or along a concrete joint (“external waterbar”). Waterbars are typically used in pre-applied waterproofing applications, where the sealing element is installed in place before the concrete joint to be waterproofed has been formed. Waterbars are provided in various shapes and sizes to adapt to the requirements of the sealing application. Flat and dumbbell-shaped waterbars are typically used for sealing of construction and contraction joints whereas waterbars with an expansion element, such as a “centerbulb”, are used for sealing of expansion joints. The centerbulb is typically provided as a hollow profile, which allows wider range of movement in transverse, lateral, or shear directions without excessively stretching the material.

The method for sealing a concrete joint using an internal waterbar typically comprises steps of placing the waterbar inside the joint to be formed such that the center portion of the waterbar is positioned in the middle of the planned concrete joint. The installation of the waterstop can be conducted, for example, by using a split formwork, which allows the insertion of the waterstop through the formwork. Typically, at least one of the side flanges of the waterbar is fixed to reinforcing steel bars in order to prevent undesired movement of the waterbar during casting of the concrete sections. After the first section of concrete has been casted, the formwork is removed followed by casting of the second section of concrete. The method for sealing a concrete joint using an external waterbar typically comprises steps of placing the waterbar on a base and casting the sections of concrete such that the side flanges become embedded in rear faces of the casted concrete bodies and the center portion of the waterbar is located along the formed concrete joint. External waterbars are equally suitable for sealing of expansion, construction, and contraction joints.

Most commonly used materials for waterbars include metals and polymers, such as rubbers, for example styrene-butadiene rubber, butyl rubber, nitrile rubber, and ethylene propylene diene monomer (EPDM) rubber, and thermoplastics, particularly polyolefins and polyvinylchloride (PVC). The polymeric materials do not bond well to concrete and, therefore, the side flanges of a waterbars are typically provided with multiple raised ribs, fins, or other protrusions, which provide mechanical interlocking to the concrete structures and a seal against flow of water when embedded in the concrete structure. Strip-like thermoplastic profiles can be easily produced by extrusion techniques but the complexity of the shapes of the laterally extending flanges complicates the production process and increases the production costs. Furthermore, waterbars are typically composed of relatively stiff materials to enable effective anchoring of the side flanges to casted concrete structures via fins, ribs and other protrusions. Due to the stiffness of the material and the presence of the protrusions, waterbars cannot be stored in form of rolls like waterproofing membranes, which increases the amount of space required for transportation and storage of the waterbars.

A waterproofing membrane can be “post-applied” to an existing concrete structure or “pre-applied” before the concrete structure to be waterproofed has been formed. In the first case, the membrane is adhered to a surface of the concrete structure to be waterproofed by using adhesive bonding means or by using sealing tapes. In pre-applied waterproofing applications, the membrane is placed with its barrier layer facing against the surface of the underlying concrete structure or formwork and fresh concrete is then cast against the opposite surface of the membrane thereby fully and permanently bonding the membrane to the surface of the hardening concrete body.

Commonly used materials for waterproofing membranes include plastics, in particular thermoplastics such as plasticized polyvinylchloride (p-PVC), polyolefins, thermoplastic polyolefins (TPO), and elastomers such as ethylene-propylene diene monomer (EPDM). These materials show a low bonding strength to adhesives that are commonly used in waterproofing applications, such as epoxy adhesives, polyurethane adhesives, and cementitious compositions. Therefore, a contact layer or coating, for example, a fleece backing or a layer of pressure sensitive adhesive, is typically used to improve the bonding of the waterproofing membrane to the structure to be waterproofed. Some commercially available membranes for pre-applied waterproofing applications comprise a waterproofing layer and a layer of non-woven fabric as a contact layer, which is adhered to the barrier layer via an adhesive layer. The adhesive layer is used to secure the contact layer to the barrier layer but also to enable improved bonding between the barrier layer and fresh concrete casted against the contact layer. However, the presence of the adhesive layer increases the production costs of these types of waterproofing membranes and the layer of non-woven fabric in practice prevents the sealing of seams formed between overlapped edges of membranes by heat-welding.

There is thus a need for a novel type of sealing element, which builds high adhesion strength to fresh concrete and which sealing element is thus suitable for use as a waterbar for sealing of joints formed between casted sections of concrete and also as a waterproofing membrane for protecting underground building structures against penetration of water.

### SUMMARY OF THE INVENTION

The objective of the present invention is to provide a sealing element, which fully and permanently bonds to concrete and other cementitious compositions cast onto the sealing element after hardening. Another objective of the present invention is to provide a sealing element suitable for sealing of concrete joints and for protecting below ground building structures, such as basements and tunneling structures, against penetration of water.

It was surprisingly found that a sealing element comprising a filled polymeric layer comprising a polyvinylchloride resin, at least one ethylene vinyl acetate copolymer having a content of a structural unit derived from vinyl acetate of at least 30 wt.-%, and at least 5 wt.-% at least one inorganic filler can solve or at least mitigate the problems related to State-of-the-Art polymeric waterbars and waterproofing membranes.

Particularly, it was found out that the filled polymeric layer fully and permanently bonds to concrete and other cementitious compositions cast against its surface after hardening. This enables providing waterbars without the presence of raised ribs, fins, or other protrusions and waterproofing membranes without additional contact layers or coatings, which are typically required to enable bonding to cementitious compositions.

The subject of the present invention is a sealing element as defined in claim 1.

One of the advantages of the sealing element of the present invention is that it enables providing waterbars and waterproofing membranes having a simplified structure, which can be produced with reduced costs compared to waterbars and waterproofing membranes of prior art.

Another advantage of the sealing element of the present invention is that it enables providing waterbars with reduced dimensions, particularly with a reduced width, since the surface(s) of the sealing element fully and permanently bond to fresh concrete and other cementitious compositions.

A still another advantage of the sealing element of the present invention is that enables providing a waterbar using flexible polymer blends, which enables storing of the waterbars in form of rolls.

Other subjects of the present invention are presented in other independent claims. Preferred aspects of the invention are presented in the dependent claims.

### BRIEF DESCRIPTION OF THE DRAWINGS

FIG. 1 shows a cross-section of a sealing element (1) composed of a filled polymeric layer (2).

FIG. 2. shows a cross-section of a sealing element (1) composed of a filled polymeric layer (2), wherein the upper and lower major surfaces of the filled polymeric layer (2) contain a surface structure (3, 4).

FIG. 3 shows a cross-section of a sealing element (1) composed of a filled polymeric layer (2) and a polymeric carrier layer (5), wherein the upper major surface of the polymeric carrier layer (5) is directly connected to the lower major surface of the filled polymeric layer (2).

FIG. 4 shows a cross-section of a sealing element (1) composed of a filled polymeric layer (2) and a polymeric carrier layer (5), wherein the upper major surface of the filled polymeric layer (2) contains a surface structure (3) and wherein the upper major surface of the polymeric carrier layer (5) is directly connected to the lower major surface of the filled polymeric layer (2).

### DETAILED DESCRIPTION OF THE INVENTION

The subject of the present invention is a sealing element (1) comprising a filled polymeric layer (2) comprising:
a) A polymer component comprising a polyvinylchloride resin and at least one ethylene vinyl acetate copolymer and
b) At least one inorganic filler,
   wherein the at least one ethylene vinyl acetate copolymer has a content of a structural unit derived from vinyl acetate of at least 30 wt.-%, preferably at least 50 wt.-%, based on the weight of the copolymer, and wherein the at least one inorganic filler comprises at least 5 wt.-%, preferably at least 10 wt.-%, of the total weight of the filled polymeric layer (2).

The term “polymer” refers to a collective of chemically uniform macromolecules produced by a polyreaction (polymerization, polyaddition, polycondensation) where the macromolecules differ with respect to their degree of polymerization, molecular weight, and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “copolymer” refers in the present disclosure to a polymer derived from more than one species of monomer (“structural unit”). The polymerization of monomers into copolymers is called copolymerization. Copolymers obtained by copolymerization of two monomer species are known as bipolymers and those obtained from three and four monomers species are called terpolymers and quaterpolymers, respectively.

The term “polyolefin” refers in the present disclosure to homopolymers and copolymers obtained by polymerization of olefins optionally with other types of comonomers.

The term “α-olefin” designates an alkene having the molecular formula CₓH₂ₓ (x corresponds to the number of carbon atoms), which features a carbon-carbon double bond at the first carbon atom (α-carbon). Examples of α-olefins include ethylene, propylene, 1-butene, 2-methyl-1-propene (isobutylene), 1-pentene, 1-hexene, 1-heptene and 1-octene. For example, neither 1,3-butadiene, nor 2-butene, nor styrene are referred as “α-olefins” according to the present document.

The term “rubber” refers in the present disclosure to a polymer or a polymer blend, which is capable of recovering from large deformations, and which can be, or already is, modified to a state in which it is essentially insoluble (but can swell) in a boiling solvent, in particular xylene. Typical rubbers are capable of being elongated or deformed to at least 200% of their original dimension under an externally applied force, and will substantially resume the original dimensions, sustaining only small permanent set (typically no more than about 20%), after the external force is released. As used herein, the term “rubber” may be used interchangeably with the term “elastomer.”

The term “molecular weight” designates the molar mass (g/mol) of a molecule or a part of a molecule, also referred to as “moiety”. The term “average molecular weight” refers to number or weight average molecular weight (Mₙ, Mw) of an oligomeric or polymeric mixture of molecules or moieties. The molecular weight can be determined by conventional methods, preferably by gel permeation-chromatography (GPC) using polystyrene as standard, styrene-divinylbenzene gel with porosity of 100 Angstrom, 1000 Angstrom and 10000 Angstrom as the column, and depending on the molecule, tetrahydrofurane as a solvent at 35° C. or 1,2,4-trichlorobenzene as a solvent at 160° C.

The term “melting temperature” designates a temperature at which a material undergoes transition from the solid to the liquid state. The melting temperature (Tₘ) is preferably determined by differential scanning calorimetry (DSC) according to ISO 11357-3:2018 standard using a heating rate of 2° C./min. The measurements can be performed with a Mettler Toledo DSC 3+ device and the Tₘ values can be determined from the measured DSC-curve with the help of the DSC-software. In case the measured DSC-curve shows several peak temperatures, the first peak temperature coming from the lower temperature side in the thermogram is taken as the melting temperature (Tₘ).

The term “glass transition temperature” (T_{g}) designates the temperature above which temperature a polymer component becomes soft and pliable, and below which it becomes hard and glassy. The glass transition temperature is preferably determined by dynamical mechanical analysis (DMA) as the peak of the measured loss modulus (G″) curve using an applied frequency of 1 Hz and a strain level of 0.1%.

The “amount or content of at least one component X” in a composition, for example “the amount of the at least one thermoplastic polymer” refers to the sum of the individual amounts of all thermoplastic polymers contained in the composition. Furthermore, in case the composition comprises 20 wt.-% of at least one thermoplastic polymer, the sum of the amounts of all thermoplastic polymers contained in the composition equals 20 wt.-%.

The term “normal room temperature” refers to the temperature of 23° C.

The sealing element of the present invention comprises a filled polymeric layer comprising a polymer component and at least one inorganic filler.

The term “layer” refers in the present disclosure generally to a sheet-like element having upper and lower major surfaces, i.e. top and bottom surfaces and a thickness defined between the upper and lower major surfaces. Preferably, a layer has a length and width at least 5 times, preferably at least times, more preferably at least 25 times greater than the maximum thickness of the layer. The term “polymeric layer” refers in the present disclosure to a layer comprising a continuous phase composed of one or more polymers.

Preferably, the filled polymeric layer is operative to bond with a cementitious composition casted against it. The term “operative to bond with a cementitious composition” is understood to mean that that a surface the layer forms a permanent bond to a fresh cementitious composition casted against it after hardening. The term “fresh cementitious composition” or “liquid cementitious composition” designate cementitious compositions before hardening, particularly before setting.

The term “cementitious composition” designates concrete, shotcrete, grout, mortar, paste or a combination thereof. The terms “paste”, “mortar”, “concrete”, “shotcrete”, and “grout” are well-known terms in the state-of-the-art. Pastes are mixtures comprising a hydratable cement binder, usually Portland cement, masonry cement, or mortar cement. Mortars are pastes additionally including fine aggregate, for example sand. Concrete are mortars additionally including coarse aggregate, for example crushed gravel or stone. Shotcrete is concrete (or sometimes mortar) conveyed through a hose and pneumatically projected at high velocity onto a surface. Grout is a particularly flowable form of concrete used to fill gaps. The cementitious compositions can be formed by mixing required amounts of certain components, for example, a hydratable cement, water, and fine and/or coarse aggregate, to produce the particular cementitious composition.

According to one or more embodiments, the filled polymeric layer is free of cross-linking agents suitable for cross-linking polyvinylchloride, preferably free of cross-linking agents.

According to one or more embodiments, the at least one inorganic filler comprises at least 15 wt.-%, preferably at least 25 wt.-%, of the total weight of the filled polymeric layer. According to one or more further embodiments, the at least one inorganic filler comprises 10-75 wt.-%, preferably 15-70 wt.-%, more preferably 20-65 wt.-%, even more preferably 25-60 wt.-%, of the total weight of the filled polymeric layer.

According to one or more embodiments, wherein the polymer component comprises at least 15 wt.-%, preferably at least 25 wt.-%, of the total weight of the filled polymeric layer. According to one or more further embodiments, the polymer component comprises 10-75 wt.-%, preferably 15-70 wt.-%, more preferably 20-65 wt.-%, even more preferably 25-60 wt.-%, of the total weight of the filled polymeric layer.

According to one or more embodiments, the polyvinylchloride resin comprises 15-85 wt.-%, preferably 25-75 wt.-%, more preferably 30-70 wt.-%, even more preferably 35-65 wt.-%, of the total weight of the polymer component.

Preferably, polyvinylchloride resin has a K-value determined by using the method as described in ISO 1628-2-1998 standard in the range of 50-85, more preferably 65-75. The K-value is a measure of the polymerization grade of the PVC-resin and it is determined from the viscosity values of the PVC homopolymer as virgin resin, dissolved in cyclohexanone at 30° C.

According to one or more embodiments, the at least one ethylene vinyl acetate copolymer comprises 15-85 wt.-%, preferably 25-75 wt.-%, more preferably 30-70 wt.-%, even more preferably 35-65 wt.-%, of the total weight of the polymer component.

According to one or more embodiments, the at least one ethylene vinyl acetate copolymer has a content of a structural unit derived from vinyl acetate of 35-90 wt.-%, preferably 50-90 wt.-%, more preferably 50-85 wt.-%, even more preferably 50-80 wt.-%, still more preferably 55-80 wt.-%, most preferably 55-75 wt.-%, based on the weight of the copolymer.

Ethylene vinyl acetate copolymers having the content of a structural unit derived from vinyl acetate in the above cited ranges have been found out as especially suitable for use in the polymer component. Without being bound to any theory it is believed that such ethylene vinyl acetate copolymers show improved miscibility with the polyvinylchloride resin as well as high inorganic filler capacity, which enables providing the filled polymeric layer with a particularly high content of the at least one inorganic filler. On the other hand, good miscibility of the at least one ethylene vinyl acetate copolymer with the polyvinylchloride resin and the high content of the at least one inorganic filler have been found out to improve the mechanical properties and concrete adhesion strength of the filled polymeric layer.

Particularly suitable copolymers for use as the at least one ethylene vinyl acetate copolymer include ethylene vinyl acetate bipolymers and terpolymers, such as ethylene vinyl acetate carbon monoxide terpolymers.

Suitable ethylene vinyl acetate bipolymers and terpolymers are commercially available, for example, under the trade name of Escorene® (from Exxon Mobil), under the trade name of Primeva® (from Repsol Quimica S.A.), under the trade name of Evatane® (from Arkema Functional Polyolefins), under the trade name of Greenflex® (from Eni versalis S.p.A.), under the trade name of Levapren® (from Arlanxeo GmbH), and under the trade name of Elvaloy® (from Dupont). Polymer blends of polyvinylchloride resin and one or more ethylene vinyl acetate copolymers as also suitable. Such blends are commercially available, for example, under the trade name of Baymod® (from Arlanxeo GmbH).

According to one or more embodiments, the at least one ethylene vinyl acetate copolymer comprises at least one ethylene vinyl acetate bipolymer having a content of a structural unit derived from vinyl acetate of 50-90 wt.-%, preferably 55-90 wt.-%, more preferably 60-85 wt.-%, even more preferably 60-80 wt.-%, based on the weight of the bipolymer. Generally, the expression “the at least one component X comprises at least one component XN”, such as “the at least one ethylene vinyl acetate copolymer comprises at least one ethylene vinyl acetate bipolymer” is understood to mean in the context of the present disclosure that a composition that the polymer component comprises one or more first ethylene vinyl acetate bipolymers as representatives of the at least one ethylene vinyl acetate copolymer.

According to one or more embodiments, the particles of the at least one inorganic filler are distributed throughout the entire volume of the filled polymeric layer.

The term “distributed throughout” means that essentially all portions of the filled polymeric layer contain particles of the at least one inorganic filler but it does not necessarily imply that the distribution of the particles is completely uniform throughout the filled polymeric layer.

It may also be preferable that the filled polymeric layer comprises a homogeneously mixed mixture of the polymer component and the at least one inorganic filler. A “homogeneously mixed mixture” refers in the present disclosure to compositions, in which the individual constituents are distributed substantially homogeneously in the composition. A homogeneously mixed mixture of the polymer component and the at least one inorganic filler refers, therefore, to compositions in which the particles of the at least one inorganic filler are homogeneously/uniformly distributed in a polymer phase comprising the polyvinylchloride resin and at least one ethylene vinyl acetate copolymer. For a person skilled in the art it is clear that within such mixed compositions there may be regions formed, which have a slightly higher concentration of one of the constituents than other regions and that a 100% homogeneous distribution of all the constituents is generally not achievable. Such mixed compositions with “imperfect” distribution of constituents, however, are also intended to be included by the term “homogeneously mixed mixture” in accordance with the present invention.

According to one or more embodiments, the at least one inorganic filler is selected from the group consisting of inert mineral fillers and mineral binders.

According to one or more embodiment, the at least one inorganic filler comprises at least one inert mineral filler.

The term “inert mineral filler” refers to mineral fillers, which, unlike mineral binders do not undergo a hydration reaction in the presence of water. Suitable mineral fillers to be used as the at least one inorganic filler include, for example, sand, granite, calcium carbonate, magnesium carbonate, clay, expanded clay, diatomaceous earth, pumice, mica, kaolin, dolomite, xonotlite, perlite, vermiculite, Wollastonite, barite, cristobalite, silica, fumed silica, fused silica, glass beads, hollow glass spheres, ceramic spheres, bauxite, comminuted concrete, and zeolites.

The term “sand” refers in the present document mineral clastic sediments (clastic rocks) which are loose conglomerates (loose sediments) of round or angular small grains, which were detached from the original grain structure during the mechanical and chemical degradation and transported to their deposition point, said sediments having an SiO₂ content of greater than 50 wt.-%, in particular greater than 75 wt.-%, particularly preferably greater than 85 wt.-%. The term “calcium carbonate” when used as inert mineral filler refers to solid particulate substances produced from chalk, limestone or marble by grinding and/or precipitation.

According to one or more embodiments, the at least one inert mineral filler is selected from the group consisting of sand, granite, calcium carbonate, magnesium carbonate, clay, expanded clay, diatomaceous earth, pumice, mica, kaolin, potash, dolomite, xonotlite, perlite, vermiculite, Wollastonite, barite, cristobalite, silica (quartz), fumed silica, fused silica, bauxite, comminuted concrete, and zeolites, preferably from the group consisting of calcium carbonate, magnesium carbonate, diatomaceous earth, pumice, mica, dolomite, xonotlite, perlite, vermiculite, Wollastonite, barite, and comminuted concrete.

According to one or more embodiments, the at least one inorganic filler is composed of the at least one inert mineral filler.

According to one or more embodiment, the at least one inorganic filler comprises at least one mineral binder.

The term “mineral binder” refers in the present disclosure to mineral materials, which undergo a hydration reaction in the presence of water. Suitable mineral binders for use as the at least one inorganic filler include hydraulic binders, non-hydraulic binders, latent hydraulic binders, and pozzolanic binders. Particularly, the term “mineral binder” refers to non-hydrated mineral binders, i.e. to unreacted mineral binders that have not yet reacted in a hydration reaction.

According to one or more embodiment, the at least one inorganic filler comprises at least one hydraulic binder.

The term “hydraulic binder” refers to substances, which react with water in a hydration reaction under formation of solid mineral hydrates or hydrate phases, which are not soluble in water or have a low water-solubility. Therefore, hydraulic binders, such as Portland cement, can harden and retain their strength even when exposed to water, for example underwater or under high humidity conditions. In contrast, the term “non-hydraulic binder” refers to substances, which harden by reaction with carbon dioxide and which, therefore, do not harden in wet conditions or under water.

Examples of suitable hydraulic binders to be used as the at least one hydraulic binder include hydraulic cements and hydraulic lime. The term “hydraulic cement” refers here to mixtures of silicates and oxides including alite, belite, tricalcium aluminate, and brownmillerite.

Commercially available hydraulic cements can be divided in five main cement types according to DIN EN 197-1, namely, Portland cement (CEM I), Portland composite cements (CEM II), blast-furnace cement (CEM III), pozzolan cement (CEM IV) and composite cement (CEM V). These five main types of hydraulic cement are further subdivided into an additional 27 cement types, which are known to the person skilled in the art and listed in DIN EN 197-1. Naturally, all other hydraulic cements that are produced according to another standard, for example, according to ASTM standard or Indian standard are also suitable for use as the at least one mineral binder.

According to one or more embodiments, the at least one inorganic filler comprises at least one non-hydraulic binder.

Examples of suitable non-hydraulic binders to be used as the at least one inorganic filler include air-slaked lime (non-hydraulic lime) and gypsum. The term “gypsum” refers in the present disclosure to any known form of gypsum, in particular calcium sulfate dehydrate, calcium sulfate α-hemihydrate, calcium sulfate ß-hemihydrate, or calcium sulfate anhydrite or mixtures thereof.

According to one or more embodiments, the at least one inorganic filler comprises at least one latent hydraulic binder.

The term “latent hydraulic binder” refers in the present disclosure to type II concrete additives with a “latent hydraulic character” as defined in DIN EN 206-1:2000 standard. These types of mineral binders are calcium aluminosilicates that are not able to harden directly or harden too slowly when mixed with water. The hardening process is accelerated in the presence of alkaline activators, which break the chemical bonds in the binder's amorphous (or glassy) phase and promote the dissolution of ionic species and the formation of calcium aluminosilicate hydrate phases.

Examples of suitable latent hydraulic binders to be used as the at least one inorganic filler include ground granulated blast furnace slag. Ground granulated blast furnace slag is typically obtained from quenching of molten iron slag from a blast furnace in water or steam to form a glassy granular product and followed by drying and grinding the glassy into a fine powder.

According to one or more embodiments, the at least one inorganic filler comprises at least one pozzolanic binder.

The term “pozzolanic binder” refers in the present disclosure to type II concrete additives with a “pozzolanic character” as defined in DIN EN 206-1:2000 standard. These types of mineral binders are siliceous or aluminosilicate compounds that react with water and calcium hydroxide to form calcium silicate hydrate or calcium aluminosilicate hydrate phases.

Examples of suitable pozzolanic binders to be used as the at least one inorganic filler include natural pozzolans, such as trass, and artificial pozzolans, such as fly ash and silica fume. The term “fly ash” refers in the present disclosure to the finely divided ash residue produced by the combustion of pulverized coal, which is carried off with the gasses exhausted from the furnace in which the coal is burned. The term “silica fume” refers in the present disclosure to fine particulate silicon in an amorphous form. Silica fume is typically obtained as a by-product of the processing of silica ores such as the smelting of quartz in a silica smelter which results in the formation of silicon monoxide gas and which on exposure to air oxidizes further to produce small particles of amorphous silica.

The at least one inorganic filler is preferably present in the filled polymeric layer as individual solid particles or as aggregates of one or more solid particles, which are dispersed in a continuous phase comprising the PVC resin and/or the at least one ethylene vinyl acetate copolymer. The expression “dispersed in a continuous phase” is understood to mean that the individual solid particles or aggregates of one or more solid particles are at least partially, preferably completely surrounded by the continuous phase comprising the PVC resin and/or the at least one ethylene vinyl acetate copolymer. In case the filled polymeric layer contains one or more mineral binders, i.e. mineral fillers that undergo a hydration reaction in the presence of water, it is essential that these do not form interconnected solid networks of hydrated mineral binders within the filled polymeric layer. Consequently, it may be preferred that the filled polymeric layer is essentially free, more preferably completely free, of interconnected solid networks of hydrated mineral binders at least as long as the sealing element has not been installed in place, i.e. used in any type of waterproofing application.

Preferably, the at least one inorganic filler has:
a d₉₈ particle size of not more than 500 μm, more preferably not more than 350 μm, even more preferably not more than 250 μm, still more preferably not more than 100 μm and/or
a median particle size d₅₀ of not more than 150 μm, more preferably not more than 100 μm, even more preferably not more than 50 μm, still more preferably not more than 25 μm and/or
d₁₀ particle size of not more than 25 μm, more preferably not more than 15 μm, even more preferably not more than 5 μm, still more preferably not more than 2.5 μm.

The term “particle size” refers in the present disclosure to the area-equivalent spherical diameter of a particle (Xₐᵣₑₐ). The term doo particle size refers in the present disclosure to a particle size below which 90% of all particles by volume are smaller than the do value. In analogy, the term “median particle size d₅₀” refers to a particle size below which 50% of all particles by volume are smaller than the d₅₀ value and the term “d₁₀ particle size” refers to a particle size below which 10% of all particles by volume are smaller than the d₁₀ value.

A particle size distribution can be measured by laser diffraction according to the method as described in standard ISO 13320:2009 using a wet or dry dispersion method and a Mastersizer 2000 device (trademark of Malvern Instruments Ltd, GB).

According to one or more embodiments, the at least one inorganic filler has a median particle size d₅₀ in the range of 0.1-50 μm, preferably 0.15-35 μm, more preferably 0.25-25 μm, even more preferably 0.30-20 μm, still more preferably 0.35-15 μm, most preferably 0.5-10 μm.

According to one or more embodiments, the filled polymeric layer further comprises:
c) At least one plasticizer for the polyvinylchloride resin.

The type of the at least one plasticizer is not particularly restricted in the present invention. Suitable plasticizers for the PVC-resin include but are not restricted to, for example, linear or branched phthalates such as di-isononyl phthalate (DINP), di-nonyl phthalate (L9P), diallyl phthalate (DAP), di-2-ethylhexyl-phthalate (DEHP), dioctyl phthalate (DOP), diisodecyl phthalate (DIDP), and mixed linear phthalates (911P). Other suitable plasticizers include phthalate-free plasticizers, such as trimellitate plasticizers, adipic polyesters, and biochemical plasticizers. Examples of biochemical plasticizers include epoxidized vegetable oils, for example, epoxidized soybean oil and epoxidized linseed oil and acetylated waxes and oils derived from plants, for example, acetylated castor wax and acetylated castor oil.

Particularly suitable phthalate-free plasticizers to be used in the waterproofing layer include alkyl esters of benzoic acid, dialkyl esters of aliphatic dicarboxylic acids, polyesters of aliphatic dicarboxylic acids or of aliphatic di-, tri- and tetrols, the end groups of which are unesterified or have been esterified with monofunctional reagents, trialkyl esters of citric acid, acetylated trialkyl esters of citric acid, glycerol esters, benzoic diesters of mono-, di-, tri-, or polyalkylene glycols, trimethylolpropane esters, dialkyl esters of cyclohexanedicarboxylic acids, dialkyl esters of terephthalic acid, trialkyl esters of trimellitic acid, triaryl esters of phosphoric acid, diaryl alkyl esters of phosphoric acid, trialkyl esters of phosphoric acid, and aryl esters of alkanesulphonic acids.

According to one or more embodiments, the at least one plasticizer for the polyvinylchloride resin comprises 1.5-40 wt.-%, preferably 2.5-35 wt.-%, more preferably 5-35 wt.-%, even more preferably 5-30 wt.-%, of the total weight of the filled polymeric layer.

According to one or more embodiments, the filled polymeric layer further comprises:
d) At least one nucleation agent.

Nucleation agents are substances which when added to polymers support generation of crystallization seeds in the polymer melt thus supporting formation of an increased number of crystals and accelerating crystallization. Examples of suitable nucleating agents for use in the filled polymeric layer include sheet silicates, fumed silica, carbon black, graphite, titanium dioxide, citric acid, quartz powder, and talcum. It goes without saying that the at least one nucleating agent is different from the at least one inorganic filler. According to one or more embodiments, the at least one nucleating agent is talcum, preferably having a median particle size d₅₀ of not more than 50 μm, preferably not more than 35 μm, more preferably not more than 25 μm, even more preferably not more than 20 μm, still more preferably not more than 15 μm.

According to one or more embodiments, the at least one nucleation agent comprises 0.1-7.5 wt.-%, preferably 0.25-5 wt.-%, more preferably 0.35-3.5 wt.-%, even more preferably 0.35-2.5 wt.-%, of the total weight of the filled polymeric layer.

The filled polymeric layer may further comprise one or more additives such as UV- and heat stabilizers, antioxidants, flame retardants, dyes, pigments such as titanium dioxide, matting agents, antistatic agents, impact modifiers, biocides, and processing aids such as lubricants, slip agents, antiblock agents, and denest aids. It is however preferred, that the total amount of these types of additives comprises not more than 15 wt.-%, preferably not more than 10 wt.-%, more preferably not more than 5 wt.-%, of the total weight of the filled polymeric layer.

According to one or more embodiments, the filled polymeric layer comprises at least one heat stabilizer. According to one or more embodiments, the at least one heat stabilizer comprises 0.1-10 wt.-%, preferably 0.5-5 wt.-%, more preferably 1-3.5 wt.-%, of the total weight of the filled polymeric layer.

Suitable heat stabilizers to be used in the filled polymeric layer include all customary polymer stabilizers, especially polyvinylchloride stabilizers in solid or liquid form, for example, those based on Ca/Zn, Ba/Zn, Pb, Sn or on organic compounds (OBS), and also acid-binding phyllosilicates such as hydrotalcite.

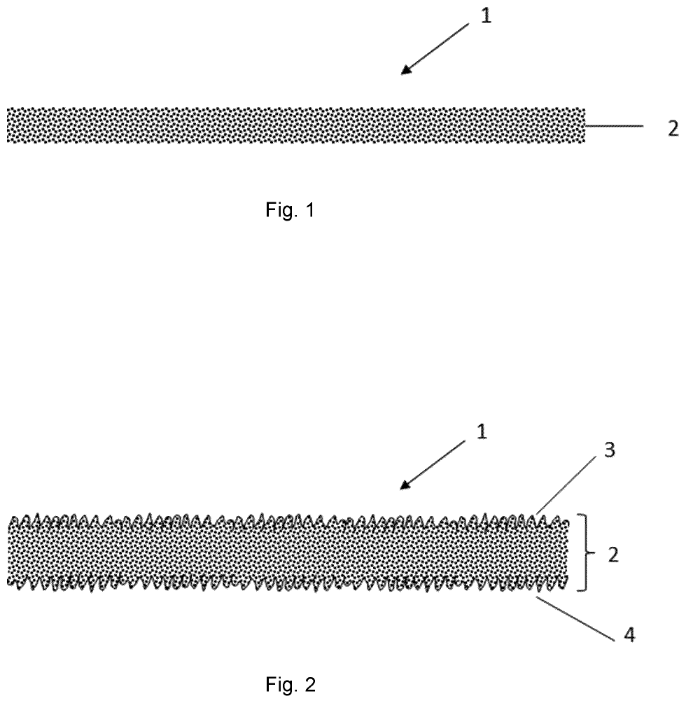

The upper and lower major surfaces of the filled polymeric layer may be substantially planar/smooth as shown in FIG. 1 or they can contain a surface structure (3, 4), which can be characterized as surface roughness, as shown in FIG. 2.

The term “surface roughness” refers to unevenness of a surface, which can be quantified, for example, by use of two-dimensional (2D) surface roughness parameters as defined in ISO 4287 standard and/or with three-dimensional (3D) surface roughness parameters defined as defined in ISO 25178 standard.

According to one or more embodiments, the upper and/or lower major surfaces of the filled polymeric layer comprise a surface structure to enable increased bonding strength to fresh cementitious compositions after hardening. The increased bonding strength to cementitious compositions may result from increased surface area of the filled polymeric layer, which enables the increased number of molecular interactions between the cementitious composition and the surface of the filled polymeric layer compared to a filled polymeric layer having a smooth surface.

A filled polymeric layer having a surface structure can be obtained, for example, by extruding or foam extruding a molten polymer composition comprising the constituents of the filled polymeric layer. On the other hand, a filled polymeric layer having a smooth surface can also be subjected to a mechanical surface treatment step, such as grinding, brushing, and abrasive blasting to produce the desired surface structure.

According to one or more further embodiments, the sealing element is a single-layer waterbar that is composed of the filled polymeric layer. Preferably, the single layer waterbar has a center portion and first and second side portions extending outwardly from the center portion.

The thickness of the single layer waterbar may remain constant or variate along the width and/or length of the waterbar. Furthermore, the top and bottom surfaces of the single-layer waterbar can contain protrusions such as ridges, which typically run in the longitudinal (machine) direction of the waterbar. However, it is also possible that the thickness of the single-layer waterbar remains substantially constant along the width and/or length of the waterbar and/or that the top and bottom surfaces of the single-layer waterbar are substantially free of protrusions, such as ridges or grooves.

Generally, the preferred dimensions, such as thickness, width, and length, of the single layer waterbar depend on the intended application, mainly on the anticipated hydrostatic head of water against which the waterbar is installed and on the dimension of the concrete joint to be sealed. It may, for example, be preferred that the single layer waterbar has a width in the range of 50-1500 mm, more preferably 100-1000 mm. The “width” of a waterbar is understood to mean the dimension of the waterbar, which is measured in direction of the width of the joint opening to be sealed with the waterbar.

According to one or more embodiments, the single-layer waterbar has a maximum thickness of 1-25 mm, preferably 2.5-20 mm, more preferably 3.5-15 mm, even more preferably 5-15 mm and/or a minimum thickness of 0.5-25 mm, preferably 1-20 mm, more preferably 1.5-15 mm, even more preferably 2.5-15 mm. The maximum and minimum thickness of the waterbar or single layer waterbar can be determined by using a measurement method as defined in DIN EN 1849-2-2019-09 standard.

According to one or more embodiments, the mass per unit area of the single layer waterbar is in the range of 1000-50000 g/m², preferably 1500-35000 g/m², more preferably 2500-25000 g/m², even more preferably 3500-20000 g/m². The mass per unit area of a single layer waterbar can be determined by measuring the mass of test piece of the single layer waterbar having a given area and dividing the measured mass by the area of the test piece.

Preferably, the single layer waterbar fulfils the general requirements for sealing elements used for sealing of expansion, contraction, or construction joints in concrete structures, particularly the requirements as defined in the following standards:

DIN 18541 parts 1 and 2; BS 903 and BS 2571; CRD-C 572-74, ASTM D 412-75, and ASTM D 638; and DIN 18195:2017-07, DIN 18197:2018-01, and DIN 7865:2015-02.

According to one or more embodiments, the center portion of the single layer waterbar is in a form of an expansion element, which is configured such that it can stretch in lateral and/or transverse direction beyond the normal elastic ability of the material of which it is made of. This type of expansion element can be in any provided in any suitable form, such as in form of a hollow profile having a closed or open cross section, such as an arch-, bellows-, or loop-shaped cross-section. These types of expansion elements allow a wider range of movement in transverse, lateral or shear directions than a planar element composed of the same material. They also enable greater amount of movement without excessively stretching the material.

According to one or more embodiments, the expansion element is in a form of a hollow profile having a closed cross-section and inner and outer major surfaces. These types of expansion elements are commonly known as “center bulbs”. The type of the closed cross-section of the hollow profile is not particularly restricted. It may be, for example, preferable that the hollow profile has a circular-, oval-, hexagonal-, pentagonal-, square, or triangular-shaped cross section.

Instead of a center bulb, the expansion element may also be provided in form a hollow profile having an open cross-section. According to one or more embodiments, the expansion element is in a form of a hollow profile having an open cross-section and upper and lower major surfaces. These types of cross-sections may be preferred, for example, in order to enable a simplified production process of the single layer waterbar. The type of the open cross-section of the hollow profile is not particularly restricted. It may be, for example, preferable that the hollow profile has U-, V-, Z, or W-shaped cross-section or a loop-, an arch-, or a bellows-shaped cross-section.

According to one or more embodiments, sealing element further comprises a polymeric carrier layer, wherein the filled polymeric layer and the polymeric carrier layer are directly or indirectly connected to each other over at least a portion of their opposing major surfaces. Sealing elements according to these embodiments are especially suitable for use waterproofing membranes.

The filled polymeric layer and the polymeric carrier layer can be indirectly connected to each other, for example, via a connecting layer, such as a layer of adhesive or via a fiber-based layer, or a combination thereof. In case a porous connecting layer, such as an open weave fabric, the filled polymeric layer may be partially directly connected and partially indirectly connected to the polymeric carrier layer.

The expression “directly connected” is understood to mean in the context of the present invention that no further layer or substance is present between the layers, and that the opposing surfaces of the two layers are directly connected to each other or adhere to each other. At the transition area between the two layers, the materials forming the layers can also be present mixed with each other.

According to one or more embodiments, the polymeric carrier layer has upper and lower major surfaces, wherein at least a portion of the upper major surface of the polymeric carrier layer is directly connected to a bottom major surface of the filled polymeric layer. According to one or more embodiments, at least 50%, preferably at least 75 wt.-%, more preferably at least 95%, of the area of the upper major surface of the polymeric carrier layer is directly connected to the lower major surface of the filled polymeric layer.

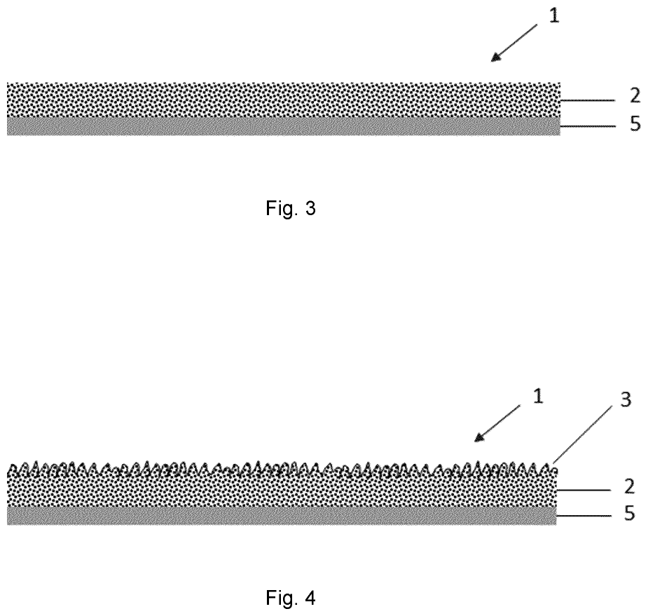

The upper major surface of the filled polymeric layer on the side opposite to the side of the polymeric carrier layer may be substantially planar/smooth as shown in FIG. 3 or it can contain a surface structure (3), which can be characterized as surface roughness, as shown in FIG. 4.

According to one or more embodiments, the upper major surface of the filled polymeric layer comprises a surface structure to enable increased bonding strength to fresh cementitious compositions after hardening.

The composition of the polymeric carrier layer is not particularly restricted, and it mainly depends on the intended use of the sealing element. However, the polymeric carrier layer should be as waterproof as possible and not to decompose or be mechanically damaged even under prolonged influence of water or moisture.

It may be generally be preferred that the polymeric carrier layer is in the form of a flexible plastic layer. This allows the sealing element to be wound into rolls, typically during production, transported the construction site, unwound from the rolls, and easily applied to a surface of a substrate to be waterproofed.

According to one or more embodiments, the polymeric carrier layer has a tensile modulus of elasticity determined according to EN ISO 527-3:2018 of not more than 750 MPa, preferably not more than 500 MPa, more preferably not more than 350 MPa, even more preferably not more than 250 MPa, still more preferably not more than 150 MPa.

According to one or more embodiments, the polymeric carrier layer comprises at least one polymer selected from the group consisting of polyvinylchloride, polyolefins, halogenated polyolefins, rubbers, and ketone ethylene esters, preferably from the group consisting of polyvinylchloride, polyolefins, and ketone ethylene esters.

According to one or more embodiments, the at least one polymer has:
a melting temperature (Tₘ) determined by DSC according to ISO 11357-3:2018 standard in the range of 55-250° C., preferably 60-200° C., more preferably 65-175° C., even more preferably 70-165° C., still more preferably 75-155° C. and/or
a melt flow rate a melt flow rate determined according to ISO 1133-1:2011 (190° C./2.16 kg) of not more than 250 g/10 min, preferably not more than 150 g/10 min, more preferably not more than 125 g/10 min, even more preferably not more than 100 g/10 min, still more preferably not more than 50 g/10 min and/or
a glass transition temperature (T_{g}) determined by dynamical mechanical analysis (DMA) as the peak of the measured loss modulus (G″) curve using an applied frequency of 1 Hz and a strain level of 0.1% of at or below 0° C., preferably at or below −10° C., more preferably at or below −20° C., even more preferably at or below −25° C., still more preferably at or below-30° C. and/or
a flexural modulus at 23° C. determined according to ISO 178:2019 standard of not more than 1000 MPa, preferably not more than 750 MPa, more preferably not more than 500 MPa, even more preferably not more than 350 MPa, still more preferably not more than 250 MPa, most preferably not more than 150 MPa.

According to one or more embodiments, the at least one polymer is selected from the group consisting of polyvinylchloride, ethylene vinyl acetate copolymers, ethylene-acrylic ester copolymers, ethylene-α-olefin copolymers, propylene-α-olefin copolymers, polyethylene, polypropylene, chlorosulfonated polyethylene, ethylene propylene diene monomer rubber, styrene-butadiene rubber (SBR), and polyisobutylene (PIB), preferably from the group consisting of polyvinylchloride, ethylene vinyl acetate copolymers, ethylene-α-olefin copolymers, and polyethylene.

According to one or more embodiments, the at least one polymer comprises a polyvinylchloride and/or at least one ethylene vinyl acetate copolymer.

Preferably, the at least one polymer comprises at least 5 wt.-%, more preferably at least 25 wt.-%, even more preferably at least 35 wt.-%, still more preferably at least 50 wt.-%, most preferably at least 75 wt.-%, of the total weight of the polymeric carrier layer. According to one or more embodiments, the at least one polymer comprises 15-97.5 wt.-%, preferably 35-95 wt.-%, more preferably 50-95 wt.-%, even more preferably 75-95 wt.-%, of the total weight of the polymeric carrier layer.

According to one or more further embodiments, the polymeric carrier layer comprises the polymer component of the filled polymeric layer, wherein the polymer component comprises at least 50 wt.-%, preferably at least 75 wt.-%, more preferably at least 85 wt.-%, of the total weight of the polymeric carrier layer.

The polymeric carrier layer can further comprise, in addition to the at least one polymer, one or more additives such as UV- and heat stabilizers, antioxidants, plasticizers, fillers, flame retardants, dyes, pigments such as titanium dioxide and carbon black, matting agents, antistatic agents, impact modifiers, biocides, and processing aids such as lubricants, slip agents, antiblock agents, and denest aids. It is, however, preferred that the total amount of these types of additives is not more than 45 wt.-%, preferably not more than 35 wt.-%, more preferably not more than 25 wt.-%, even more preferably not more than 15 wt.-%, of the total weight of the polymeric carrier layer.

The thickness of the polymeric carrier layer is not subjected to any particular restrictions and it depends on the intended use of the sealing element. However, sealing elements comprising a polymeric carrier layer having a thickness of above 15 mm or below 0.05 mm are usually not practical in waterproofing applications. Preferably, the polymeric carrier layer has a thickness of at least 0.05 mm, more preferably at least 0.1 mm, even more preferably at least 0.25 mm. According to one or more embodiments, the polymeric carrier layer has a thickness in the range of 0.05-15 mm, preferably 0.1-10 mm, more preferably 0.15-5 mm, even more preferably 0.25-3.5 mm, still more preferably 0.35-2.5 mm. The thickness of the polymeric carrier layer can be determined by using a measurement method as defined in DIN EN 1849-2-2019-09 standard.

In case the sealing element comprises, in addition to the filled polymeric layer, the polymeric carrier layer, the mass per unit area of the filled polymeric layer can be somewhat lower than in case of a sealing element composed of the filled polymeric layer.

According to one or more embodiments, the sealing element comprises the filled polymeric layer and the polymeric carrier layer, wherein the mass per unit area of the filled polymeric layer is in the range of 50-2500 g/m², preferably 100-2000 g/m², more preferably 150-1500 g/m², even more preferably 200-1250 g/m², still more preferably 250-1000 g/m², most preferably 300-850 g/m².

There are no strict limitations for the width and length of the polymeric carrier layer, and these depend on the intended use of the sealing element. The term “width” and “length” refer to the two perpendicular dimensions measured in the horizontal plane of the top and bottom surfaces of a sheet-like element. Generally, the “width” of a sheet like element is the smaller of the horizontal dimensions of the sheet-like element. Consequently, the “width” of the polymeric carrier layer refers to the minor dimension measured in the horizontal plane of the polymeric carrier layer in a direction perpendicular to the length of the polymeric carrier layer.

According to one or more embodiments, the sealing element is a waterproofing membrane comprising the filled polymeric layer and the polymeric carrier layer, wherein the filled polymeric layer and the polymeric carrier layer are directly or indirectly, preferably directly, connected to each other over at least a portion of their opposing major surfaces.

The waterproofing membrane can be provided in form of a narrow strip or in form of a broad sheet. According to one or more embodiments, the polymeric carrier layer has a width in the range of 10-500 mm, preferably 50-350 mm, more preferably 75-250 mm. According to one or more further embodiments, the polymeric carrier layer has a width in the range of 0.75-5 m, preferably 0.85-3.5 m, more preferably 1-2.5 m.

According to one or more embodiments, the sealing element comprises, in addition to the filled polymeric layer and the polymeric carrier layer, a second filled polymeric layer, wherein the second filled polymeric layer and the polymeric carrier layer are directly or indirectly connected to each other over at least a portion of their opposing surfaces.

According to one or more embodiments, at least a portion of the lower major surface of the polymeric carrier layer is directly connected to the upper major surface of the second filled polymeric layer. According to one or more embodiments, at least 50%, preferably at least 75 wt.-%, more preferably at least 95% of the area of the lower major surface of the polymeric carrier layer is directly connected to the upper major surface of the second filled polymeric layer.

The second filled polymeric layer preferably comprises:
a) A polymer component comprising a polyvinylchloride resin and at least one ethylene vinyl acetate copolymer and
b) At least one inorganic filler,
   wherein the at least one ethylene vinyl acetate copolymer has a content of a structural unit derived from vinyl acetate of at least 30 wt.-%, preferably at least 50 wt.-%, based on the weight of the copolymer, and wherein the at least one inorganic filler comprises at least 5 wt.-%, preferably at least 10 wt.-%, of the total weight of the second filled polymeric layer.

The preferred embodiments of the polymer component and the at least one inorganic filler have already been discussed above.

The lower major surface of the second filled polymeric layer on the side opposite to the side of the polymeric carrier layer may be substantially planar/smooth or it can contain a surface structure, which can be characterized as surface roughness.

According to one or more embodiments, the sealing element is a waterproofing membrane comprising the filled polymeric layer, the polymeric carrier layer, and the second filled polymeric layer, wherein the filled polymeric layer and the polymeric carrier layer are directly or indirectly, preferably directly, connected to each other over at least a portion of their opposing major surfaces and wherein the second filled polymeric layer and the polymeric carrier layer are directly or indirectly, preferably directly, connected to each other over at least a portion of their opposing major surfaces.

The preferences given above for the filled polymeric layer, the polymer component, the at least one inorganic filler, the polymeric carrier layer, and to the second filled polymeric layer apply equally apply equally to all subjects of the present invention unless otherwise stated.

Another subject of the present invention is use of the sealing element according to the present invention as a waterbar, preferably for sealing of a joint in a concrete structure, or as a waterproofing membrane, preferably for waterproofing of an above or below ground building structure.

Another subject of the present invention is a method for sealing a joint between two sections of concrete, the method comprising steps of providing a sealing element of the present invention and casting a first and a second section of concrete such that:
A first side portion of the sealing element becomes embedded in the first section of concrete,
A second side portion of the sealing element becomes embedded in the second section of concrete, and
A center portion of the sealing element is positioned in the joint formed between the first and second casted concrete sections.

The first and second sections of concrete can form a part of any structural or civil engineering structure, which is to be sealed against moisture and water, such as an above ground or underground structure, for example a building, garage, tunnel, landfill, water-retaining structure, pond, or dike.

The details of the method for sealing a joint between two sections of concrete depend on the type of the joint to be sealed, particularly if the joint is to be sealed as an internal or as an external concrete joint.

According to one on or more embodiments, the joint between two sections of concrete is an internal joint and the method comprises steps of:
I) Positioning the sealing element such that the center portion of sealing element is arranged between upper and lower parts of a split formwork,
II) Optionally securing the first side portion of the sealing element to one or more reinforcing steel bars,
III) Casting the first section of concrete such that the first side portion of the sealing element becomes embedded in concrete, and
IV) Casting a second section of concrete such that the second side portion of the sealing element becomes embedded in concrete.

According to one or more further embodiments, the joint between two sections of concrete is an external joint and the method comprises steps of:
I′) Providing a sealing element of the present invention,
II′) Positioning the sealing element to a base onto which concrete is to be cast,
III′) Casting a first and a second section of concrete such that:
   A center portion of the sealing element is located in or along the joint formed between the casted sections of concrete,
   A top surface of a first side portion of the sealing element forms a bond to the surface of the first section of concrete, and
   A top surface of the second side portion of the sealing element forms a bond to the surface of the second section of concrete.

Another subject of the present invention is a method for waterproofing a substrate using the sealing device of the present invention.

According to one or more embodiments, the method for waterproofing a substrate comprises steps of:
i) Applying a sealing element according to the present invention to a surface of the substrate such that the upper major surface of the filled polymeric layer is facing away from the surface of the substrate,
ii) Casting a fresh concrete composition onto the upper major surface of the filled polymeric layer, and
iii) Letting the fresh concrete composition to harden.

The substrate to be waterproofed can be any structural or civil engineering structure, which is to be sealed against moisture and water.

According to one or more further embodiments, the method for waterproofing a substrate comprises steps of:
i′) Providing a sealing element according to the present invention,
ii′) Applying a layer of an adhesive on at least a portion of a surface of the substrate,
iii′) Contacting the layer of adhesive with the upper major surface of the filled polymeric layer.

The adhesive can be a fresh cementitious composition, or a synthetic resin-based adhesive composition, for example, an epoxy-based, polyurethane-based, or acrylic-based one-component or two-component adhesive composition or a non-reactive or reactive thermoplastic-based or rubber-based adhesive composition.

According to one or more further embodiments, the method for waterproofing a substrate comprises steps of:
i″) Providing a sealing element according to the present invention,
ii”) Applying a layer of an adhesive composition on at least a portion of the surface of the substrate to form a first adhesive film and on the upper major surface of the filled polymeric layer to form a second adhesive film,
iii″) Contacting the first and second adhesive films with each other to effect adhesive bonding between the substrate and the sealing element.

The adhesive composition used in this these embodiments is preferably a solvent- or water-based contact adhesive, such as a solvent- or water-based acrylic adhesive. Suitable solvent- and water-based contact adhesives are commercially available, for example, under the trade name of Sarnacol® (from Sika AG).

Still another subject of the present invention is a method for producing a sealing element of the present invention, the method comprising a step of extruding or co-extruding a first molten polymer composition comprising the constituents of the filled polymeric layer through an extruder die.

The first molten polymer composition is preferably obtained by melt-processing a first starting composition comprising the constituents of the filled polymeric layer. The term “melt-processing” refers in the present disclosure to a process, in which at least one molten polymeric component is intimately mixed with at least one other component, which may be another molten polymeric component or a solid component, such as a filler or an additive, until a melt blend, i.e. a substantially homogeneously mixed mixture of the polymeric component(s) and the other constituents is obtained.

The melt processing of a starting composition can be conducted as a batch process using any conventional mixer, such as a Brabender, Banbury, or roll mixer or as continuous process using a continuous type mixer, preferably an extruder, such as a single screw or a twin-screw extruder or a planetary roller extruder. The constituents of the starting composition are preferably fed into the mixer using a conventional feeding system comprising a feed hopper and feed extruder. Alternatively, some or all the constituents of the starting composition may be directly fed into the mixer as individual streams, as a premix, a dry blend, or as a master batch. Furthermore, the constituents of the starting composition can first be processed in a compounding extruder to pellets or granules, which are then fed into the mixer.

Especially in case the at least one inorganic filler comprises hydraulic binders, it may be preferred that the first starting composition contains only minor amounts of water. According to one or more embodiments, the first starting composition comprises less than 10 wt.-%, preferably less than 7.5 wt.-%, more preferably less than 5 wt.-%, even more preferably less than 3.5 wt.-%, still more preferably less than 2.5 wt.-%, of water, based on the total weight of the first starting composition.

According to one or more embodiments, the first molten polymer composition comprises a blowing gas, which is released from the melt-processed blend through surface(s) of the extruded profile discharged from the extruder die. The blowing gas may be added to the first molten polymer composition to enable providing the filled polymeric layer with a desired surface structure.

In case the first molten polymer composition comprises a blowing gas, the melt-shaped layer discharged from the extruder die is first inflated due to volume increase of the blowing gas resulting in formation of a closed cell structure. Eventually, surface(s) of the melt-shaped layer is penetrated by the still expanding blowing gas, which results in formation of open or semi-open cells, pores, cavities, and other surface imperfections, which can be characterized as “a surface structure”.

Physical and chemical blowing agents may be used to provide the first molten polymer composition with a blowing gas. Chemical blowing agents are preferably added to the first starting composition and the blowing gas is then generated during the melt-processing of the first starting composition. Physical blowing agents are preferably added directly to the first molten polymeric composition before it is extruded through the extruder die.

Suitable physical blowing agents include gaseous and liquid physical blowing agents. Liquid physical blowing agents include volatile liquids which produce gas through vaporization. Suitable liquid physical blowing agents generally include water, short-chain aliphatic hydrocarbons, for example having from five to seven carbon atoms, and their halogenated, particularly chlorinated and fluorinated, derivatives. Particularly suitable liquid physical blowing agents have a standard boiling point measured at a pressure of 1 bar of not more than 250° C., preferably not more than 200° C. The standard boiling point of a liquid physical blowing agent can be measured using an ebulliometer. Gaseous physical blowing agents, such as compressed nitrogen or carbon dioxide, can be directly injected under high pressure into the polymer melt, which is conveyed through a melt-processing apparatus, such as an extruder barrel.

Chemical blowing agents, also known as chemical foaming agents, are typically solids that liberate gas(es) by means of a chemical reaction, such as decomposition, when exposed to elevated temperatures. Inorganic, organic, exothermic, and endothermic chemical blowing agents are all equally suitable. Endothermic blowing agents may be preferred over exothermic blowing agents, since the latter have been found to have potential to trigger respiratory sensitivity, are generally not safe from a toxicological point of view or have a risk of explosion. Furthermore, by-products such as ammonia, formamide, formaldehyde or nitrosamines are released during decomposition of exothermic blowing agents and these substances have been classified as hazardous substances.

According to one or more embodiments, the first starting composition comprises at least one chemical blowing agent.

According to one or more embodiments, the at least one chemical blowing agent has a maximum decomposition peak temperature measured by Differential Scanning calorimetry (DSC) in the range of 85-225° C., preferably 95-215° C., more preferably 105-205° C., even more preferably 115-195° C. The maximum decomposition peak measured by DSC is preferably determined by using a DSC822e differential scanning calorimeter from Mettler-Toledo by keeping the sample for 2 min at 25° C., then heating the sample from 25° C. to 280° C. at a rate of 5° C./min, then keeping the sample for 2 min at 280° C. and finally cooling the sample from 280° C. to 25° C. at a rate of 10° C./min.

Suitable substances to be used as the at least one chemical blowing agent include, for example, azodicarbonamide, azobisisobutyronitrile, azocyclohexyl nitrile, dinitrosopentamethylene tetramine, azodiamino benzene, calcium azide, 4,4′-diphenyldisulphonyl azide, benzenesulphonyl hydrazide, 4,4-oxybenzenesulphonyl semicarbazide, 4,4-oxybis(benzenesulphonyl hydrazide), diphenyl sulphone-3,3-disulphonyl hydrazide, p-toluenesulphonyl hydrazide, p-toluenesulphonyl semicarbazide, trihydrazino triazine, N,N′-dimethyl-N,N′-dinitrosoterephthalamide, diazoaminobenzene, diazoaminotoluene, hydrazodicarbonamide, barium azodicarboxylate, 5-hydroxytetrazole, sodium bicarbonate, ammonium carbonate, ammonium bicarbonate, potassium bicarbonate, and organic acids.

Suitable organic acids for use as the at least one chemical blowing agent include, for example, monocarboxylic acids, such as acetic acid and propionic acid, solid polycarboxylic acids, such as solid, hydroxy-functionalized or unsaturated dicarboxylic, tricarboxylic, tetracarboxylic or polycarboxylic acids, in particular citric acid, tartaric acid, malic acid, fumaric acid, and maleic acid.

Most of the above listed preferable chemical blowing agents, such as sodium bicarbonate, are solid at normal room temperature and are typically provided in powder form. The particle size of such powders is preferably not too low in order to prevent premature decomposition the chemical blowing agent during a pre-mixing process, for example, during pre-mixing of the constituents of the first starting composition. A narrow particle size distribution may also be preferred in order to better control the decomposition temperature of the chemical blowing agent.

According to one or more embodiments, the at least one chemical blowing agent is present in the first starting composition in form of solid particles having a median particle size d₅₀ in the range of 0.5-100 μm, preferably 1.0-75 μm, more preferably 2.5-50 μm, even more preferably 5-35 μm.

Although some of the compounds used in the present invention are characterized as useful for specific functions, the use of these compounds is not limited to their stated functions. For example, it is also possible that some of the substances presented above as chemical blowing agents can also be used as activators for the at least one chemical blowing agent.

According to one or more embodiments, the at least one chemical blowing agent is selected from the group consisting of bicarbonates of formula XHCO₃ and carbonates of formula X₂CO3, wherein X stands for a generic cation, in particular Na⁺, K⁺, NH₄⁺, ½ Zn²⁺, ½ Mg²⁺, or ½ Ca²⁺, preferably from the group consisting of bicarbonates of formula XHCO₃, wherein X stands for a generic cation, in particular Na⁺, K⁺, NH₄⁺, ½ Zn²⁺, ½ Mg²⁺, or ½ Ca²⁺, more preferably from the group consisting of sodium and potassium bicarbonates.

The at least one chemical blowing agent preferably comprises not more than 3.5 wt.-%, more preferably not more than 2.5 wt.-%, even more preferably not more than 2 wt.-%, still more preferably not more than 1.5 wt.-%, of the total weight of the first starting composition.

According to one or more embodiments, the at least one chemical blowing agent comprises at least 0.05 wt.-%, preferably at least 0.1 wt.-%, more preferably at least 0.15 wt.-%, of the total weight of the first starting composition. According to one or more further embodiments, the at least one chemical blowing agent comprises 0.01-2.5 wt.-%, preferably 0.1-2.0 wt.-%, more preferably 0.15-1.5 wt.-%, even more preferably 0.25-1.25 wt.-%, still more preferably 0.35-1.25 wt.-%, of the total weight of the first starting composition.

It has been found out that increasing the amount of the chemical blowing agent in the first starting composition increases the surface roughness of the filled polymeric layer, but it can also have a negative impact on the mechanical properties, particularly on the tensile and tear strength of the filled polymeric layer. In case the sealing element is used as a single layer waterbar, use smaller amounts of the blowing agent in the first starting composition may be preferred.

The first molten polymeric composition is preferably extruded or co-extruded using an extrusion apparatus comprising an extruder and a die.

Such extrusion apparatuses are well known to a person skilled in the art. A suitable extruder comprises a barrel and a screw unit contained in the barrel or a ram. Any conventional extruders, for example, a ram extruder, single screw extruder, or a twin-screw extruder may be used. Preferably, the extruder is a screw extruder, more preferably a twin-screw extruder. The screw unit of a conventional screw extruder is typically considered to comprise feed, transition, and metering sections. In the feed section the thermoplastic composition enters the channels of the rotating screw and is conveyed towards the transition section, in which the composition is compressed and melted. The composition should be fully melted when it leaves the transition section. The function of the metering section is to homogenize the melted composition and to allow it to be metered or pumped out at constant rate. The extrusion apparatus further comprises a die, preferably a flat die, consisting of manifold, approach, and lip regions. In case of a co-extrusion process, the extrusion apparatus preferably comprises at least two extruders, preferably twin-screw extruders, and a single- or a multi-manifold die.

The extruder barrel comprises a feed port through which the material to be extruded is fed to the extruder and an outlet port through which the material leaves the barrel. The outlet port is coupled with the die via a gate or adapter piece. A mixing device may be interposed between the barrel and the die. The feed port is typically connected with a hopper to which the material to be extruded is added. It is preferred that a screen pack and a breaker plate are positioned at the end of the barrel to avoid plugging in the nozzles. The extruder further comprises heating elements, cooling elements, temperature sensors and temperature control elements to provide temperature-controlled zones along the barrel, also known as barrel zones. The extruder may comprise, for example, 3 to 8 barrel zones, preferably at least 5 barrel zones, by the use of which a temperature profile can be realized in the barrel.

Preferably, a significant part, preferably the entire amount of the polymer component is fed into the extruder through the feed port. It may be preferred that at least part of the at least one inorganic filler is fed into the extruder through another port located downstream from the feed port. The term “downstream” designates in the present document the direction to the outlet port. For example, it may be advantageous that not more than 50 wt.-%, preferably not more than 30 wt.-%, more preferably not more than 10 wt.-%, of the total amount of the at least one inorganic filler is fed into the extruder through the feed port with the entire amount of the polymer component and that the remaining portion of the at least one inorganic filler is fed into the extruder through a another port located downstream from the feed port.

It may also be preferable that only a portion of the at least one chemical blowing agent, if used, is fed into the extruder through the feed port and that at least 10 wt.-%, preferably at least 20 wt. % of the total amount of it is fed into the extruder through another port located downstream from the feed port.

Some or all of the constituents of the first starting composition can also be mixed to obtain a premix, masterbatch, or a dry blend, which is then fed into the extruder through the feed port. The premix can be carried out using any type of conventional blending apparatus, which are known to a person skilled in the art. In a premixing process, the particles of the polymer component are mixed at an elevated temperature with the other constituents, such as with the at least one inorganic filler and/or with the at least one chemical blowing agent, if used, to obtain a homogeneously mixed mixture. It is also possible to that some or all of the constituents of the first starting composition are processed in a compounding extruder to pellets or granules, which are then fed into the extruder though the feed port.

It may furthermore be preferable that some or all of the constituents of the first starting composition are mixed or fused in a dry blender to a dry blend or to a plasticized dry blend, in case the first starting composition comprises a plasticizer. In the typical dry blending process, particles of the polyvinylchloride resin intermingle with all the other constituents to produce a homogenously mixed material. Mixing or fusion in a dry blending process is accomplished by a combination of stress and temperature.

In an exemplary dry blending process, the polyvinylchloride resin and additives, such as heat stabilizers, are added to a dry blender and heated, for example, to a temperature of 80-90° C., then the plasticizer, if used, is added and the mixture is further heated, for example, to a temperature of 100-110° C. Then the at least one inorganic filler, nucleating agent, if used, such as talcum, and the blowing agent, if used, such as sodium bicarbonate, are added together and mixed for a short time, for example, 2-3 minutes, during cooling of the mixture. Alternatively, the blowing agent can be added separately at the end of the blending process in a separate cooling mixer. It is furthermore possible that the blowing agent is not added into the dry blend but fed directly to the extruder.

The preferred extrusion temperature depends on the embodiment of the sealing element, in particular on the type of the polymers contained in the polymer component. The term “extrusion temperature” refers to the temperature of the extruded composition in the die outlet. According to one or more embodiments, the extrusion temperature is in the range of 100-250° C., preferably 120-240° C., more preferably 125-220° C., even more preferably 135-200° C.

The preferred extrusion pressure depends on the embodiment of the sealing element, in particular on the type of the polymers contained in the polymer component and on the amount of the at least one inorganic filler in the first starting composition. The term “extrusion pressure” refers to the pressure of the composition at the end of the metering zone just before the composition enters the die inlet.

According to one or more embodiments, the extrusion pressure is in the range of 20-350 bar, preferably 30-240 bar, more preferably 35-200 bar, even more preferably 40-130 bar.

The extrusion process may be conducted by using different temperature profiles, such as an increasing temperature profile where the temperature increases downstream the barrel, a decreasing temperature profile where the temperature decreases downstream the barrel, and a humped temperature profile where the temperature increases from the feed port toward a certain set point, for example toward the middle of the barrel. It may be preferable that the extrusion process is conducted by using a humped temperature profile.

Preferably, at least part, such as at least 5 wt.-%, in particular at least 10 wt.-%, preferably 25 wt.-%, more preferably at least 50 wt.-%, most preferably at least 75 wt.-%, of the at least one chemical blowing agent, if used, decomposes while the first molten polymer composition is conveyed through the barrel and before it enters the extruder die. This is ensured by selection of a suitable chemical blowing agent or a suitable mixture of a chemical blowing agent and an activator and by adjusting the temperature profile in the feed, transition and metering sections. Preferably, the first molten polymer composition is maintained at a temperature, which is at least 10° C. above the decomposition temperature of the at least one chemical blowing agent as the first molten polymer composition is conveyed through the extruder barrel.

Furthermore, the extruder is preferably operated with closed venting unit(s). It is essential that at least a significant part of the blowing gases released inside the extruder barrel are kept trapped in the first molten polymer composition and not released before it exits the extruder die.

According to one or more embodiments, the method comprises a further step of extruding or co-extruding a second molten polymer composition comprising the constituents of the polymeric carrier layer through an extruder die.

Preferably, the second molten polymer composition is obtained by melt-processing a second starting composition comprising the constituents of the polymeric carrier layer.

The further details of the method for producing a sealing element depend on the embodiment of the sealing element.

According to one or more embodiments, the method for producing a sealing element comprises co-extruding the first molten polymer composition and the second molten polymer composition through a common extruder die, preferably a flat die, using a co-extrusion apparatus. Preferably, the co-extrusion apparatus comprises a first extruder for melt-processing the first starting composition and a second extruder for melt-processing the second starting composition. The first and second molten polymer compositions are extruded through a common extruder die, which can be equipped with a single- or a multi-manifold. The thickness of the extruded filled polymeric layer and the extruded polymeric carrier layer as well as the adhesion between the layers can be easily controlled by adjusting the die lip of the co-extrusion apparatus.

It may be preferred that the method for producing a sealing element comprises a further step of employing spaced apart calendar cooling rolls through which the composite article comprising the extruded filled polymeric layer and the extruded polymeric carrier layer is drawn subsequent to the co-extrusion step. The thickness of the filled polymeric layer and the polymeric carrier layer can be further controlled by adjusting the gap size between the calendar cooling rolls. Preferably, the gap between the calendar cooling rolls is adjusted such that substantially no pressure is exerted on the surface of the filled polymeric layer in order to obtain a filled polymeric layer with desired surface roughness.

According to one or more further embodiments, the method for producing a sealing element comprises extruding the first molten polymer composition through a first extruder die using a first extrusion apparatus and extruding the second molten polymer composition through a second extruder die using a second extrusion apparatus and bonding the thus obtained filled polymeric layer and polymeric carrier layer to each other. The extruded filled polymeric layer and polymeric carrier layer can be, for example, be thermally laminated to each other or adhered to each other using an adhesive. The term “thermal lamination” refers here to a process comprising partially melting at least one of the layers upon application of thermal energy followed by a cooling step, which results in formation of a bond between the layers without using a bonding agent, such as an adhesive.

According to one or more further embodiments, the method for producing a sealing element comprises extruding the second molten polymer composition through an extruder die on a bottom surface of a pre-formed filled polymeric layer or extruding the first molten polymer composition through an extruder die on a top surface of a pre-formed polymeric carrier layer. In these embodiments, the polymeric carrier layer is simultaneously formed and bonded to the previously formed filled polymeric layer or vice versa.

### EXAMPLES

The followings compounds shown in Table 1 were used in the examples:

TABLE 1

| | |
|---|---|
| PVC resin | PVC resin, K-value 70 |
| EVA 1 | Ethylene vinyl acetate copolymer, content of vinyl |
| | acetate 28 wt.-% |
| EVA 2 | Ethylene vinyl acetate carbon monoxide terpolymer, |
| | content of vinyl acetate 30 wt.-% |
| EVA 3 | Ethylene vinyl acetate copolymer, content of vinyl |
| | acetate 50 wt.-% |
| EVA 4 | Ethylene vinyl acetate copolymer, content of vinyl |
| | acetate 70 wt.-% |
| PVC/EVA | Ethylene-vinyl acetate copolymer having 65 wt.-% of |
| | vinyl acetate, milled and mixed with 15 wt.-% PVC |
| Filler | Calcium carbonate, d₅₀ particle size 3 μm |
| Talc | Talc, d₅₀ particle size 7 μm |
| Additive 1 | Acrylic-based processing aid |
| Additive 2 | Heat stabilizer |
| Additive 3 | Heat stabilizer |
| Additive 4 | Acrylic-based processing aid |
| Plasticizer | Diisononyl phthalate |
| Blowing agent | Sodium bicarbonate, decomposition temperature 50° C. |

### Preparation of Sealing Elements

The inventive and reference single layer sealing elements were produced using an extrusion apparatus comprising a single screw extruder and an extrusion die (Ref-2, Ex-7 to Ex-18) or using a two-roll mill (Ref-1, Ex-1 to Ex-6).

In the extrusion process, a starting composition containing the constituents of the filled polymeric layer was first melt-processed in the single-screw extruder. The starting compositions were provided as dry blends containing all the constituents of the starting compositions. In case a starting composition contained a chemical blowing agent (sodium bicarbonate), the extruder was operated with closed venting unit in order to prevent the escape of blowing gases before the molten polymer composition had advanced to the extruder die.

In the two-roll mill process, the ingredients were weighed out and mixed in a paper cup using a wooden spatula. The total mass for each mixture was 150 g. The roll temperatures were 176° C. and 165° C. and the roll speeds were 20 rpm and 15 rpm for the front and back roll, respectively. The milled film was pulled off the roll and set flat on a bench top to cool. Excess film was cut away and the remaining sheet of the film was placed into a 20.3 cm×20.3 cm×1.5 cm mold, which was sandwiched between two sheets of PTFE non-stick foil, which in turn was sandwiched between two aluminum pressing plates. The sample was then pressed into the mold using a Labtech heated press with a 2 minute heating cycle at 188° C. and a three minute cooling cycle. The pressure was set to 138 bar. After pressing, the sample was removed from the press and the excess material was cut away.

The constituents of the starting compositions and operating conditions of the extrusion apparatus during production of the sealing elements are presented in Tables 2 and 3. The extrusion temperature and pressure were measured at a point, where the melt-processed mass entered the inlet of the flat die.

In case of Ref-1, no sealing element could be produced to the non-compatibility of the PVC resin and the ethylene vinyl acetate copolymer.

### Preparation of the Concrete Test Specimen

For testing the adhesion strength to concrete, a layer of cured PVC plastisol composition was adhered as a back layer to the sealing elements prepared as described above so that the samples would not break during the peel strength testing.

Three samples with a dimension of 200 mm (length)×50 mm (width) were cut from each of the tested sealing element having the PVC plastisol back layer. The sample strips were placed into formworks having a dimension of 200 mm (length)×50 mm (width)×30 mm (height).

One edge of each sample strip was covered with an adhesive tape having a length of 50 mm and a width coinciding with the width of the strip to prevent the adhesion to the hardened concrete. The adhesive tapes were used to provide easier installation of the test specimens to the peel resistance testing apparatus.

For the preparation of concrete specimens, a batch of fresh concrete formulation was prepared. The fresh concrete formulation was obtained by mixing 9.0102 kg of a pre-mixed concrete product Sikacrete® 211 (available from Sika Corporation) with 0.7553 kg of water for five minutes in a tumbling mixer.

The formworks containing the sample strips were subsequently filled with the fresh concrete formulation and vibrated for seven minutes to release the entrapped air. After hardening for 24 hours under standard atmosphere (air temperature 23° C., relative air humidity 50%), the test concrete specimens were stripped from the formworks and measured for concrete peel resistances.

### Concrete Peel Resistances

The measurement of peel resistances was conducted in accordance with the procedure laid out in the standard DIN EN 1372:2015-06. A 90° peel jig apparatus was used for conducting the peel resistance measurements.

In the peel resistance measurements, a concrete specimen was clamped with the upper grip of the material testing apparatus for a length of 10 mm at the end of the concrete specimen comprising the taped section of the sample strip. Following, the strip was peeled off from the surface of the concrete specimen at a peeling angle of 90° and at a constant cross beam speed of 100 mm/min. The peeling of the sample strip was continued until a length of approximately 120 mm of the strip was peeled off from the surface of the concrete specimen. The values for peel resistance were calculated as average peel force per width of the sample strip [N/50 mm] during peeling over a length of approximately 100 mm thus excluding the first and last 10 mm of the total peeling length from the calculation.

The average peel resistance values presented in Tables 2 and 3 have been calculated as an average of two measurements conducted with the same sealing elements.

### Tensile Strength and Elongation at Break

Tensile strength and elongation at break (MD, CD) were measured according to ASTM D751 standard at a temperature of 21° C. using a Instron tensile tester and a cross head speed of 100 mm/min.

TABLE 2

| Compositions [pbw] | Ref-1 | Ex-1 | Ex-2 | Ex-3 | Ex-4 | Ex-5 | Ex-6 |
|---|---|---|---|---|---|---|---|
| PVC resin | 41.40 | 41.40 | 41.40 | 41.40 | 31.67 | 16.58 | 11.05 |
| EVA 1 | 41.40 | 0.00 | 0.00 | 0.00 | 0.00 | 0.00 | 0.00 |
| EVA 2 | 0.00 | 41.40 | 0.00 | 0.00 | 0.00 | 0.00 | 0.00 |
| EVA 3 | 0.00 | 0.00 | 41.40 | 0.00 | 0.00 | 0.00 | 0.00 |
| EVA-4 | 0.00 | 0.00 | 0.00 | 41.40 | 31.67 | 0.00 | 0.00 |
| PVC/EVA | 0.00 | 0.00 | 0.00 | 0.00 | 0.00 | 12.30 | 24.66 |
| Filler | 15.00 | 15.00 | 15.00 | 15.00 | 35.00 | 56.83 | 54.31 |
| Talc | 0.00 | 0.00 | 0.00 | 0.00 | 0.00 | 0.76 | 0.51 |
| Additive 1 | 0.00 | 0.00 | 0.00 | 0.00 | 0.00 | 0.11 | 0.07 |
| Additive 2 | 2.20 | 2.20 | 2.20 | 2.20 | 1.67 | 0.00 | 0.00 |
| Additive 3 | 0.00 | 0.00 | 0.00 | 0.00 | 0.00 | 2.10 | 1.84 |
| Plasticizer | 0.00 | 0.00 | 0.00 | 0.00 | 0.00 | 11.31 | 7.56 |
| Blowing agent | 0.00 | 0.00 | 0.00 | 0.00 | 0.00 | 0.00 | 0.00 |
| Tot | 100.00 | 100.00 | 100.00 | 100.00 | 100.01 | 99.99 | 100.00 |
| Peel [N/50 mm] after 7 days | n.a. | n.a. | n.a. | n.a | n.a. | 10 | 28 |
| Peel [N/50 mm] after 28 days | n.a. | 6 | 10 | 27 | 28 | 15 | 48 |

MD = machine direction,
CD = cross machine direction

TABLE 3

| Compositions [pbw] | Ex-7 | Ex-8 | Ref-2 | Ex-9 | Ex-10 | Ex-11 | Ex-12 | Ex-13 | Ex-14 | Ex-15 | Ex-16 | Ex-17 | Ex-18 |
|---|---|---|---|---|---|---|---|---|---|---|---|---|---|
| PVC resin | 11.31 | 11.25 | 44.36 | 11.20 | 11.14 | 31.09 | 19.53 | 17.38 | 15.20 | 13.00 | 10.87 | 15.53 | 11.05 |
| EVA/PVC | 24.63 | 24.51 | 0.00 | 24.39 | 24.27 | 29.70 | 43.60 | 38.77 | 33.91 | 29.03 | 24.26 | 33.92 | 24.18 |
| Filler | 54.36 | 54.09 | 20.00 | 53.83 | 53.57 | 13.98 | 18.65 | 27.58 | 36.53 | 45.56 | 54.41 | 36.74 | 54.23 |
| Talc | 0.00 | 0.00 | 2.04 | 0.00 | 0.00 | 1.42 | 0.89 | 0.80 | 0.70 | 0.60 | 0.50 | 0.00 | 0.00 |
| Additive 1 | 0.00 | 0.00 | 0.29 | 0.00 | 0.00 | 0.20 | 0.00 | 0.00 | 0.00 | 0.00 | 0.00 | 0.00 | 0.00 |
| Additive 3 | 2.00 | 1.99 | 2.10 | 1.98 | 1.97 | 1.47 | 2.80 | 2.50 | 2.18 | 1.88 | 1.55 | 2.18 | 1.97 |
| Additive 4 | 0.00 | 0.00 | 0.00 | 0.00 | 0.00 | 0.00 | 0.13 | 0.11 | 0.10 | 0.08 | 0.07 | 0.00 | 0.00 |
| Plasticizer | 7.71 | 7.76 | 30.30 | 7.63 | 7.60 | 21.19 | 13.33 | 11.85 | 10.37 | 8.86 | 7.40 | 10.62 | 7.57 |
| Blowing agent | 0.00 | 0.49 | 0.99 | 0.98 | 1.46 | 0.99 | 0.99 | 0.99 | 0.99 | 0.99 | 0.99 | 0.99 | 0.99 |
| Tot | 100.01 | 100.09 | 100.08 | 100.01 | 100.01 | 100.04 | 99.92 | 99.98 | 99.98 | 100.00 | 100.05 | 99.98 | 99.99 |
| Peel [N/50 mm] | 20 | 40 | 4 | 58 | 40 | 10 | 15 | 18 | 25 | 28 | 32 | 20 | 30 |
| after 7 days | | | | | | | | | | | | | |
| Peel [N/50 mm] | 36 | 85 | 5 | 112 | 80 | 12 | 17 | 20 | 30 | 40 | 70 | 32 | 43 |
| after 28 days | | | | | | | | | | | | | |
| Tensile strength MD | 5.52 | 1.72 | 5.17 | 2.21 | 1.79 | 3.10 | 2.90 | 2.69 | 2.59 | 4.00 | 2.14 | 3.79 | 3.59 |
| [N/mm²] | | | | | | | | | | | | | |
| Tensile strength CD | 4.83 | 1.03 | 2.96 | 1.52 | 1.03 | 1.93 | 1.03 | 1.03 | 0.83 | 2.07 | 1.10 | 1.72 | 2.55 |
| [N/mm²] | | | | | | | | | | | | | |
| Elongation *MD [%] | 390 | 250 | 150 | 320 | 260 | 225 | 275 | 250 | 265 | 380 | 250 | 360 | 325 |
| Elongation *CD [%] | 440 | 150 | 120 | 220 | 150 | 200 | 190 | 180 | 175 | 225 | 110 | 175 | 270 |
| Extrusion | 159 | 163 | 172 | 163 | 162 | 172 | 172 | 173.5 | 173.5 | 174 | 175.5 | 174 | 175.5 |
| temperature [° C.] | | | | | | | | | | | | | |
| Extrusion | 90 | 103 | 37 | 103 | 107 | 41.4 | 48.3 | 55.2 | 55.2 | 73.8 | 77.2 | 56.5 | 62.1 |
| pressure [bar] | | | | | | | | | | | | | |

*MD = machine direction,
CD = cross machine direction

1. A sealing element comprising a filled polymeric layer comprising:
a) a polymer component comprising a polyvinylchloride resin and at least one ethylene vinyl acetate copolymer and
b) at least one inorganic filler,
wherein the at least one ethylene vinyl acetate copolymer has a content of a structural unit derived from vinyl acetate of at least 30 wt.-%, based on the weight of the copolymer, and wherein the at least one inorganic filler comprises at least 5 wt.-% of the total weight of the filled polymeric layer.

2. The sealing element according to claim 1, wherein the filled polymeric layer is operative to bond with a fresh cementitious composition casted against its surface.

3. The sealing element according to claim 1, wherein the filled polymeric layer is free of cross-linking agents suitable for cross-linking polyvinylchloride.

4. The sealing element according to claim 1, wherein the at least one inorganic filler comprises 10-75 wt.-% of the total weight of the filled polymeric layer.

5. The sealing element according to claim 1, wherein the polymer component comprises 10-75 wt.-% of the total weight of the filled polymeric layer.

6. The sealing element according to claim 1, wherein the polyvinylchloride resin comprises 15-85 wt.-% of the total weight of the polymer component.

7. The sealing element according to claim 1, wherein the at least one ethylene vinyl acetate copolymer comprises 15-85 wt.-% of the total weight of the polymer component.

8. The sealing element according to claim 1, wherein the at least one ethylene vinyl acetate copolymer has a content of a structural unit derived from vinyl acetate of 35-90 wt.-%.

9. The sealing element according to claim 1, wherein the particles of the at least one inorganic filler are distributed throughout the entire volume of the filled polymeric layer.

10. The sealing element according to claim 1, wherein the at least one inorganic filler is selected from the group consisting of inert mineral fillers and mineral binders.

11. The sealing element according to claim 1 further comprising a polymeric carrier layer, wherein the filled polymeric layer and the polymeric carrier layer are directly or indirectly connected to each other over at least a portion of their opposing major surfaces.

12. The sealing element according to claim 11, wherein the polymeric carrier layer comprises at least one polymer selected from the group consisting of polyvinylchloride, polyolefins, halogenated polyolefins, rubbers, and ketone ethylene esters.

13. The sealing element according to claim 11, wherein the polymeric carrier layer has a thickness in the range of 0.1-10 mm and/or wherein the filled polymeric layer has a mass per unit area of in the range of 50-2500 g/m².

14. A method comprising applying the sealing element according to claim 1 as a waterbar or as a waterproofing membrane.

15. A method for sealing a joint between two sections of concrete, the method comprising steps of providing a sealing element according to claim 1 and casting a first and a second section of concrete such that:
a first side portion of the sealing element becomes embedded in the first section of concrete,
a second side portion of the sealing element becomes embedded in the second section of concrete, and
a center portion of the sealing element is positioned in the joint formed between the first and second casted concrete sections.

16. A method for waterproofing a substrate comprising steps of:
i) applying a sealing element according to claim 1 to a surface of the substrate such that the upper major surface of the filled polymeric layer is facing away from the surface of the substrate,
ii) casting a fresh cementitious composition onto the upper major surface of the filled polymeric layer, and
iii) letting the fresh cementitious composition to harden.

17. A method for producing a sealing element according to claim 1, the method comprising a step of extruding or co-extruding a first molten polymer composition comprising the constituents of the filled polymeric layer through an extruder die.

18. The method according to claim 17, wherein the first molten polymer composition has been obtained by melt-processing a first starting composition comprising the constituents of the filled polymeric layer.

19. The method according to claim 18, wherein the first starting composition further comprises at least one chemical blowing agent.

20. The method according to claim 17 comprising a further step of extruding or co-extruding a second molten polymer composition comprising the constituents of a polymeric carrier layer through an extruder die.
